(19) United States
(12) Patent Application Publication
(10) Pub. No.: US 2026/0087975 A1
(43) Pub. Date: Mar. 26, 2026

(54) DISPLAY PANEL AND DISPLAY DEVICE

(71) Applicant: Tianma Advanced Display Technology Institute (Xiamen) Co., Ltd., Xiamen (CN)

(72) Inventor: Mengmeng XIE, Xiamen (CN)

(73) Assignee: Tianma Advanced Display Technology Institute (Xiamen) Co., Ltd., Xiamen (CN)

(21) Appl. No.: 19/400,984

(22) Filed: Nov. 25, 2025

(30) Foreign Application Priority Data
Dec. 30, 2024 (CN) 202411968396.9

(51) Int. Cl. G09G 3/32

(52) U.S. Cl. CPC G09G 3/32; G09G 2300/0426; G09G 2300/0819; G09G 2310/0286; G09G 2320/0233

(57) ABSTRACT

A display panel and a display device, including shift register units, scan lines and pixel circuits. Pixel circuits are arranged in a pixel circuit row in a first direction. The scan line extends along the first direction and is connected to the pixel circuits. A length of the pixel circuit row in the first direction is L. The display panel includes two first regions. A width of one first region in the first direction is L/10. The pixel circuit row includes a first edge and a second edge in the first direction. A minimum distance between one first region and the first edge and between another one first region and the second edge is respectively L/5. The scan line includes two sites. One first region is provided with a respective one site. One site is correspondingly connected to an output terminal of a respective one shift register unit.

### CROSS-REFERENCE TO RELATED APPLICATIONS

The present application claims priority to Chinese Patent Application No. 202411968396.9 filed on December 30, 2024, the content of which is incorporated herein by reference in its entirety.

### TECHNICAL FIELD

The present disclosure relates to the field of display technologies, and in particular, to a display panel and a display device.

### BACKGROUND

A display panel is provided with scan lines and cascaded shift register units. The output terminals of the shift register units are connected to the scan lines, and the scan lines are connected to a plurality of pixels in the pixel rows. Scan signals are sequentially output through the cascaded shift register units to drive and display the pixel rows row by row. However, currently, the shift register units are arranged at two sides of the display panel, and the scan signals are transmitted from two ends of the scan lines to the middle, which results in inconsistent delay of scan signals between the two sides and the middle of the display region, leading to poor display uniformity.

### SUMMARY

The present disclosure provides a display panel and a display device.

In an aspect, an embodiment of the present disclosure provides a display panel, including shift register units, scan lines and pixel circuits. The pixel circuits are arranged in a pixel circuit row in a first direction, one of the scan lines extends along the first direction and is connected to the pixel circuits in the pixel circuit row, and a length of the pixel circuit row in the first direction is L. A display region of the display panel includes at least two first regions, and a width of one of the at least two first regions in the first direction is L/10; the pixel circuit row includes a first edge and a second edge opposite to each other in the first direction, a minimum distance between the first edge and one of the at least two first regions is L/5, and a minimum distance between the second edge and another one of the at least two first regions is L/5; and one of the scan lines includes two sites, one of the at least two first regions is provided with a respective one of the two sites, and one of the two sites is correspondingly connected to an output terminal of a respective one of the shift register units.

In another aspect, an embodiment of the present disclosure provides a display device, including a display panel, including shift register units, scan lines and pixel circuits. The pixel circuits are arranged in a pixel circuit row in a first direction, one of the scan lines extends along the first direction and is connected to the pixel circuits in the pixel circuit row, and a length of the pixel circuit row in the first direction is L. A display region of the display panel includes at least two first regions, and a width of one of the at least two first regions in the first direction is L/10; the pixel circuit row includes a first edge and a second edge opposite to each other in the first direction, a minimum distance between the first edge and one of the at least two first regions is L/5, and a minimum distance between the second edge and another one of the at least two first regions is L/5; and one of the scan lines includes two sites, one of the at least two first regions is provided with a respective one of the two sites, and one of the two sites is correspondingly connected to an output terminal of a respective one of the shift register units..

### BRIEF DESCRIPTION OF DRAWINGS

In order to better illustrate the technical solutions in the embodiments of the present disclosure or the related art, the drawings used in the description of the embodiments will be briefly illustrated as follows. It should be noted that, the drawings described below are merely some of, rather than all of the embodiments of the present disclosure. Based on these drawings, those skilled in the art can obtain other drawings without any creative efforts.

FIG. 1 is a simplified schematic diagram of a display panel according to an embodiment of the present disclosure;

FIG. 2 is a schematic diagram of another display panel according to an embodiment of the present disclosure;

FIG. 3 is a schematic diagram of another display panel according to an embodiment of the present disclosure;

FIG. 4 is a schematic diagram of another display panel according to an embodiment of the present disclosure;

FIG. 5 is a partial schematic diagram of another display panel according to an embodiment of the present disclosure;

FIG. 6 is a partial schematic diagram of another display panel according to an embodiment of the present disclosure;

FIG. 7 is a partial schematic diagram of another display panel according to an embodiment of the present disclosure;

FIG. 8 is a schematic diagram of a pixel circuit according to an embodiment of the present disclosure;

FIG. 9 is a schematic diagram of another display panel according to an embodiment of the present disclosure;

FIG. 10 is a partial schematic diagram of another display panel according to an embodiment of the present disclosure;

FIG. 11 is a schematic diagram of a shift register unit according to an embodiment of the present disclosure;

FIG. 12 is a partial schematic diagram of another display panel according to an embodiment of the present disclosure;

FIG. 13 is a schematic diagram of a shift register unit according to an embodiment of the present disclosure;

FIG. 14 is a partial schematic diagram of another display panel according to an embodiment of the present disclosure;

FIG. 15 is a schematic diagram of another display panel according to an embodiment of the present disclosure;

FIG. 16 is a schematic diagram of another display panel according to an embodiment of the present disclosure;

FIG. 17 is a schematic diagram of another display panel according to an embodiment of the present disclosure;

FIG. 18 is a cross-sectional schematic diagram along A-A′ shown in FIG. 17;

FIG. 19 is an enlarged schematic diagram of a region Q1 shown in FIG. 17;

FIG. 20 is a schematic diagram of another display panel according to an embodiment of the present disclosure;

FIG. 21 is a schematic diagram of driving a display panel according to an embodiment of the present disclosure;

FIG. 22 is a schematic diagram of another display panel according to an embodiment of the present disclosure;

FIG. 23 is a schematic diagram of driving another display panel according to an embodiment of the present disclosure;

FIG. 24 is a schematic diagram of another pixel circuit according to an embodiment of the present disclosure; and

FIG. 25 is a schematic diagram of a display device according to an embodiment of the present disclosure.

### DESCRIPTION OF EMBODIMENTS

In order to better illustrate objectives, technical solutions, and advantages of embodiments of the present disclosure, the technical solutions in embodiments of the present disclosure are described in detail with reference to the drawings. It should be noted that, the embodiments described are only some rather than all of the embodiments of the present disclosure. Based on the embodiments of the present disclosure, all other embodiments obtained by those ordinary skilled in the art without creative efforts shall fall within the protection scope of the present disclosure.

Terms used in the embodiments of the present disclosure are only for the purpose of describing specific embodiments but not intended to limit the present disclosure. Singular forms of “a/an”, “said” and “the” used in the embodiments of the present disclosure and the appended claims are also intended to include plural forms, unless the context clearly indicates other meaning otherwise.

Embodiments of the present disclosure provide a display panel. Signal input sites on a scan line are respectively arranged in two first regions of the display panel, and each of the 1/4 division line and the 3/4 division line of the display region is located in a respective one first region. In the applications, a signal on the scan line is transmitted to the left side and the right side from a position of each of the signal input sites, which can balance the delay differences of the scan signals at the two sides and the middle position of the display region and improve display uniformity. In some embodiments, the shift register unit connected to the site on the scan line is also arranged in the first region, thereby reducing a distance between the output terminal of the shift register unit and the site on the scan line. In some embodiments, further arrangements are made regarding the positional relationship and the film layer relationship between the driving signal line connected to the shift register unit and the data line. Further, in some embodiments, in order to match the design of the film layers where the driving signal line, the data line, and the scan line are located, a structure of other trace in the panel, such as the reset signal line, is designed. This is a main technical overview of the present disclosure. The technical solutions of the present disclosure are described below with specific embodiments.

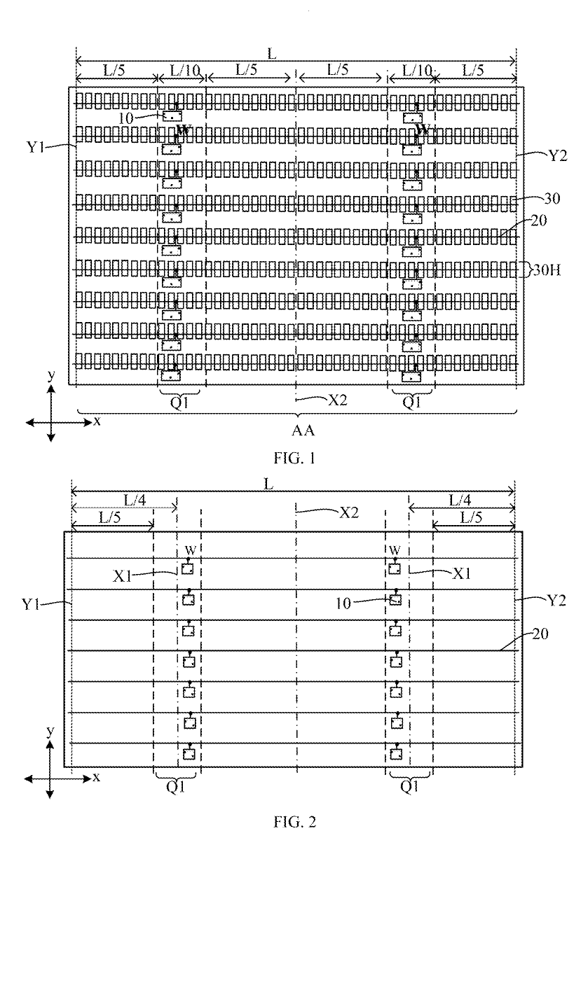

FIG. 1 is a simplified schematic diagram of a display panel according to an embodiment of the present disclosure. As shown in FIG. 1, the display panel includes a shift register unit 10, scan lines 20 and pixel circuits 30. The pixel circuits 30 are arranged in a pixel circuit row 30H in a first direction x. The scan line 20 extends along the first direction x and is connected to the pixel circuits 30 in the pixel circuit row 30H. FIG. 1 simplifies the pixel circuit 30. The pixel circuit 30 may be any type of pixel circuit in the related art. The pixel circuit 30 includes a plurality of transistors. For example, the pixel circuit 30 includes a data writing transistor. The scan lines 20 include a first scan line. The first scan line is connected to gates of a plurality of data writing transistors in the pixel circuit row 30H. For example, the pixel circuit 30 includes a light-emitting control transistor. The scan lines 20 include a second scan line. The second scan line is connected to gates of a plurality of light-emitting control transistors in the pixel circuit row 30H.

As shown in FIG. 1, a length of the pixel circuit row 30H in the first direction x is L. Herein, when measuring the length of the pixel circuit row 30H, edges of the structures of the pixel circuits 30 at two end locations are regarded as boundaries. The pixel circuit row 30H includes a first edge Y1 and a second edge Y2 opposite to each other in the first direction x. The first edge Y1 and the second edge Y2 are edges at left and right sides of the pixel circuit row 30H. The display panel includes a plurality of pixel circuit rows 30H. First edges Y1 of the plurality of pixel circuit rows 30H arranged in the second direction y are located at a same straight line. Second edges Y2 of the plurality of pixel circuit rows 30H arranged in the second direction y are also located at a same straight line. The second direction y intersects with the first direction x.

The display region AA of the display panel includes at least two first regions Q1. The display region AA is provided with a plurality of light-emitting devices (not shown in FIG. 1). The light-emitting devices are connected to the pixel circuits 30. A width of the first region Q1 in the first direction x is L/10. A minimum distance between one first region Q1 and the first edge Y1 is L/5. A minimum distance between the other first region Q1 and the second edge Y2 is L/5. The scan line 20 includes two sites W. One first region Q1 corresponds to one site W, which is correspondingly connected to an output terminal of one shift register unit 10. It can be understood that, for one scan line 20, two shift register units 10 correspondingly connected to two sites W simultaneously provide scan signals to the scan line 20.

FIG. 1 illustrates a center line of the display panel. A second virtual line X2 extending along the second direction y is a center line of the display panel, and the first edge Y1 and the second edge Y2 of the pixel circuit row 30H have a same distance from the second virtual line X2. Since a width of the first region Q1 in the first direction x is L/10, and a minimum distance between the first region Q1 and the edge of the pixel circuit row 30H is L/5, it can be known that a minimum distance between the first region Q1 and the second virtual line X2 is also L/5, and the two first regions Q1 are respectively located in the middle regions at the left and right sides of the display panel.

The display panel provided by an embodiment of the present disclosure includes two first regions Q1. The two first regions Q1 are respectively located in middle regions at the left and right sides of the display panel in the first direction x. Two sites W on the scan line 20 are disposed in one-to-one correspondence with the two first regions Q1. The site W on the scan line 20 is connected to the output terminal of the shift register unit 10. The two sites W serve as two signal input sites on the scan line 20. Scan signals provided by the shift register units 10 to the scan line 20 are transmitted towards the left side and the right side respectively from the positions of the two sites W. The arrangement of the two sites W and the regions of the two sites results in small delay differences of scan signals at two sides of the sites W, which can balance the delay differences of scan signals at different positions of the display panel in the first direction x and improve the display uniformity.

In some embodiments, as shown in FIG. 1, the shift register unit 10 connected to the site W is located in a corresponding first region Q1. That is, for one scan line 20, one site W1 is respectively provided in each of the two first regions Q1, and the shift register unit 10 connected to the one site W1 is respectively located in the corresponding first region Q1 where the site W is located. Such an arrangement can reduce winding and save wiring space in the display panel, shorten a distance between the output terminal of the shift register unit 10 and the site W connected thereto, thereby reducing the voltage drop in the transmission of the scan signals. Moreover, disposing the shift register unit 10 in the first region Q1 of the display region AA can facilitate narrowing left and right frames of the display panel.

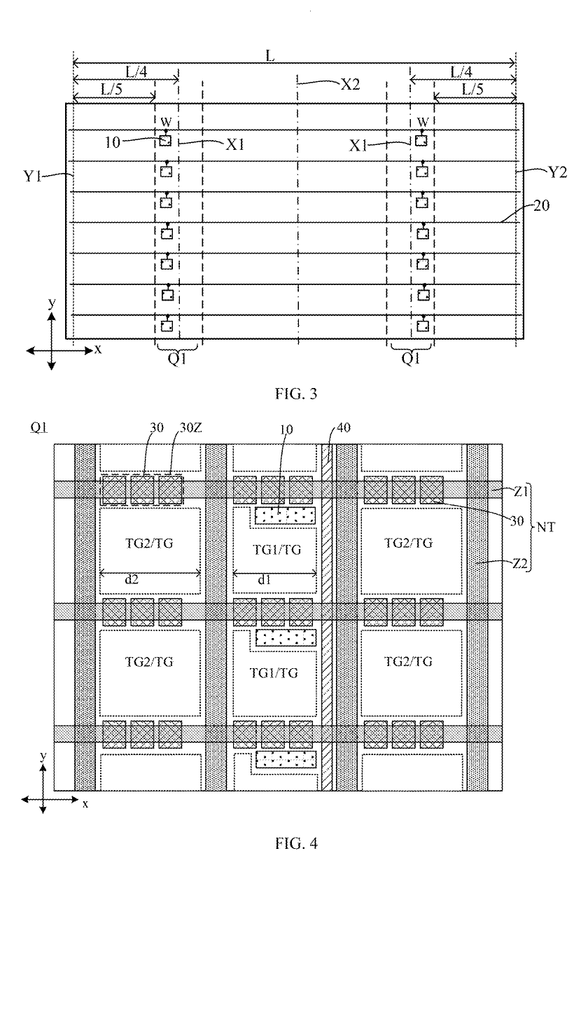

In some embodiments, FIG. 2 is a schematic diagram of another display panel according to an embodiment of the present disclosure, and FIG. 3 is a schematic diagram of another display panel according to an embodiment of the present disclosure. FIG. 2 and FIG. 3 simplify the display panel and only mark the first edge Y1 and the second edge Y2 of the pixel circuit row 30H, and do not illustrate the pixel circuits 30 in the pixel circuit row 30H. A distance between the first edge Y1 and the second edge Y2 is L. The display panel includes a first virtual line X1 extending along the second direction y, and the second direction y intersects with the first direction x. In the first direction x, a distance between the first virtual line X1 and the edge of the pixel circuit row 30H is L/4. Each of the two first regions Q1 corresponds to a respective one first virtual line X1. The two first virtual lines X1 are equivalent to a 1/4 division line and a 3/4 division line of the display panel in the first direction x. FIG. 2 illustrates that two shift register units 10 correspondingly connected to two sites W on one scan line 20 are located between two first virtual lines X1. FIG. 3 illustrates that, for two shift register units 10 correspondingly connected to two sites W on one scan line 20, one of the two shift register units 10 is located between the first virtual line X1 and the first edge Y1, and the other one of the two shift register units 10 is located between the first virtual line X1 and the second edge Y2. In the embodiments of the present disclosure, the relative positions of the two shift register units 10 connected to a same scan line 20 in the two first regions Q1 with respect to the first virtual lines X1 are designed, thereby ensuring that the two shift register units 10 in the two first regions Q1 are approximately symmetrical with respect to the second virtual line X2 (i.e., the center line of the display panel). Such an arrangement can further balance the delay differences of scan signals at different positions of the display panel in the first direction x, thereby improving the display uniformity.

In some embodiments, as shown in FIG. 2, the display panel includes a second virtual line X2 extending along the second direction y. The first edge Y1 and the second edge Y2 have a same distance from the second virtual line X2. The second virtual line X2 is a center line of the display panel. Two sites W on a single scan line 20 have a same distance from the second virtual line X2, and two shift register units 10 correspondingly connected to the two sites W also have a same distance from the second virtual line X2. In this embodiment, two sites W on one scan line 20 are arranged to be symmetrical with respect to the second virtual line X2, and the two shift register units 20 corresponding to the two sites W are also symmetrical with respect to the second virtual line X2. In this way, the scan signals input at the two sites W on the scan line 20 are substantially the same, and a voltage drops of the scan signals at the left and right sides of the display panel in the first direction x are substantially the same, thereby improving the display uniformity.

In some embodiments, FIG. 4 is a schematic diagram of another display panel according to an embodiment of the present disclosure. In an embodiment of the present disclosure, the display region of the display panel includes a transmission region TG and a non-transmission region NT. A transmittance of the transmission region TG is greater than a transmittance of the non-transmission region NT. As shown in FIG. 4, n pixel circuits 30 arranged in the first direction x form a circuit group 30Z, where n is an integer and n≥2. In an example as shown in FIG. 4, n=3. The display panel includes a first tracing region Z1 extending along a first direction x and a second tracing region Z2 extending along a second direction y. Signal lines are arranged in the first tracing region Z1 and the second tracing region Z2, respectively. The first tracing region Z1 at least partially overlaps with the circuit group 30Z. In the display panel, the first tracing region Z1, the second tracing region Z2, and the regions where the pixel circuit 30 and the shift register unit 10 are disposed form a non-transmission region NT. The non-transmission regions NT cross each other to define a plurality of transmission regions TG. In the first region Q1, the shift register unit 10 and the circuit group 30Z adjacent to each other in the second direction y form a continuous non-transmission region NT. In this embodiment of the present disclosure, the shift register unit 10 and the circuit group 30Z are adjacent to each other in the second direction y, and are relatively close to each other and arranged densely. Such an arrangement can reduce an impact of the arrangement of the shift register unit 10 on an area of the transmission region (TG) in the display panel, ensure the transmittance of the region of the shift register unit 10, and thus ensuring the display effect of transparent display in applications.

It can be understood that the display panel includes a plurality of metal layers and a plurality of insulating layers disposed on a substrate. During the fabrication of the display panel, an etching process is used to etch at least part of the insulating layers, forming hollowed-out portions, which serve as the transmission regions (TG), and the light transmittance of the transmission regions (TG) is relatively high.

FIG. 4 schematically shows that the shift register unit 10 is located below the circuit group 30Z nearest thereto. In some other embodiments, the shift register unit 10 is adjacent to the circuit group 30Z in the second direction y, and at least part of the shift register units 10 is located above the circuit group 30Z closest thereto.

In some embodiments, as shown in FIG. 4, the transmission region TG includes a first transmission region TG1 and a second transmission region TG2. A length d1 of the first transmission region TG1 in the first direction x is smaller than a length d2 of the second transmission region TG2 in the first direction x. The display panel includes a driving signal line 40 extending along the second direction y. The shift register unit 10 is connected to the driving signal line 40. The driving signal line 40 in the first region Q1 is adjacent to the first transmission region TG1. The driving signal line 40 is adjacent to one second tracing region Z2. The driving signal line 40 includes a start signal line, a clock signal line and a power line required for driving the shift register unit 10. In this embodiment of the present disclosure, the driving signal line 40 needs to occupy a certain space, the length d1 of the first transmission region TG1 in the first direction x is set to be smaller than the length d2 of the second transmission region TG2 in the first direction x, then when designing, a plurality of circuit groups 30Z in the whole display region are arranged in a regular array. During fabrication, this arrangement results in high regularity of each metal layer in the circuit groups 30Z, excellent overall etching uniformity, thereby ensuring a small difference in transistor performance in the circuits.

In some embodiments, FIG. 5 is a partial schematic diagram of another display panel according to an embodiment of the present disclosure. As shown in FIG. 5, the shift register unit 10 includes a driving module 11 and an output module 12 arranged in a first direction x. An output terminal of the output module 12 is connected to a site W on the scan line 20. In the shift register units 10 in the two first regions Q1, the driving module 11 and the output module 12 are arranged in a same order. As shown in FIG. 5, in the shift register units 10 in the two first regions Q1, the driving modules 11 are both on the left sides and the output modules 12 are both on the right sides. In some other embodiments, it is also possible that in the shift register units 10 in the two first regions Q1, the driving modules 11 are both on the right sides and the output modules 12 are both on the left sides, which will not be illustrated herein again.

Referring to FIG. 4, the display panel provided by this embodiment of the present disclosure may be a transparent display panel. The shift register unit 10 is disposed in the first region Q1, which affects a shape and an area of the transmission region TG at the position of the shift register unit 10. The driving modules 11 and the output modules 12 in the shift register units 10 in the two first regions Q1 are arranged in a same order, which is beneficial to making the shapes and the areas of the transmission regions TG at the position of the shift register units 10 in the two first regions Q1 be substantially the same, thereby ensuring a same transmittance in the two first regions Q1, and thus making the display effect of transparent display better. In this embodiment, combined with the positional design of the two sites W, for example, by setting the two sites W to have a same distance from the second virtual line X2 (as schematically shown in FIG. 2) or with a small difference in distance, it can balance the delay difference of the scan signals on the left and right sides of the display panel in the first direction x, thereby improving the display uniformity.

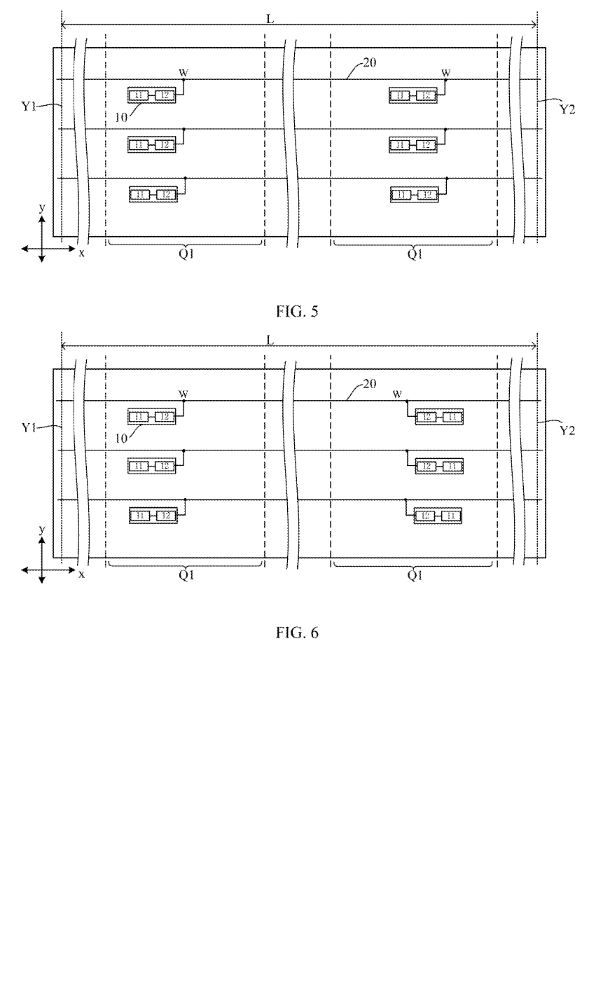

In some other embodiments, FIG. 6 is a partial schematic diagram of another display panel according to an embodiment of the present disclosure. As shown in FIG. 6, the shift register unit 10 includes a driving module 11 and an output module 12 arranged in a first direction x. An output terminal of the output module 12 is connected to a site W on the scan line 20. The arrangement order of the driving modules 11 and the output modules 12 in the two first regions Q1 is in a mirror relationship. In the shift register unit 10 in one first region Q1, the driving module 11 is on the left side and the output module 12 is on the right side; while in the shift register units 10 in the other first region Q1, the driving module 11 is on the right side and the output module 12 is on the left side. With reference to the embodiment of FIG. 4, when applied to transparent display, the shift register unit 10 is disposed in the first region Q1, which affects a shape and an area of the transmission region TG at the position of the shift register unit 10. However, the arrangement order of the driving modules 11 and the output modules 12 in the two first regions Q1 is set to be in a mirror relationship. Although the shapes of the transmission regions TG at the positions of the shift register units 10 in the two first regions Q1 are slightly different, this design enables the driving signal line and the shift register unit 10 in each of the first regions Q1 to have a same relative position (for example, each of the driving signal lines is located at a side of the shift register unit 10 away from the center line of the display panel). When combined with the positional design of the two sites W, for example, by setting the two sites W to have a same distance from the second virtual line X2 (as shown in FIG. 2), the circuit structures and the signal sites in the two first regions Q1 are symmetrically designed. The scan signals are transmitted from the positions of the two sites W to the left side and the right side respectively, resulting in a small difference in the delay of the scan signals on two sides of the sites W, thereby improving the display uniformity.

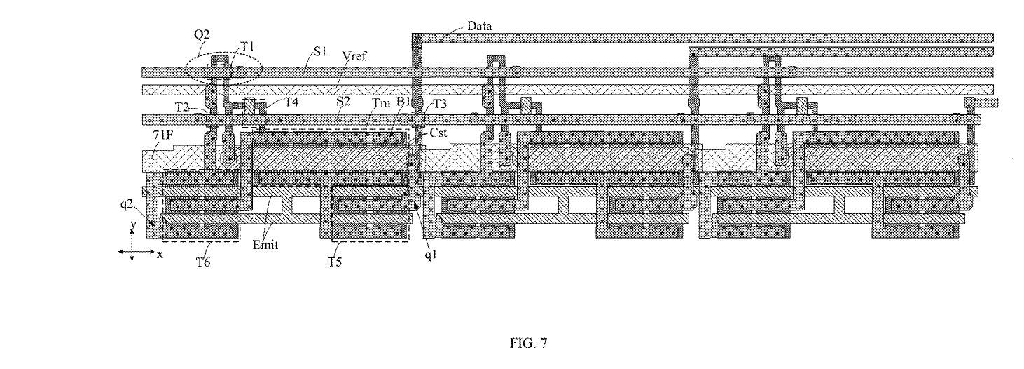

FIG. 7 is a partial schematic diagram of another display panel according to an embodiment of the present disclosure, and FIG. 8 is a schematic diagram of a pixel circuit according to an embodiment of the present disclosure. FIG. 7 schematically shows three pixel circuits at the position of one of the circuit groups 30Z. Referring to FIG. 7 and FIG. 8, the pixel circuit includes a driving transistor Tm, a gate reset transistor T1, an electrode reset transistor T2, a data writing transistor T3, a threshold compensation transistor T4, a first light-emitting control transistor T5, a second light-emitting control transistor T6, and a storage capacitor Cst. The pixel circuit needs to be driven by a strobe signal S1, a strobe signal S2, a light-emitting control signal Emit, a reset signal Vref, a first power signal Pvdd, and a data signal Data. An electrode of the light-emitting device LED is connected to the pixel circuit, and another electrode of the light-emitting device LED is connected to a second power signal Pvee. The light-emitting device LED is a light-emitting diode (LED), such as a mini-LED or a micro-LED. A scan line S1, a scan line S2, a light-emitting control line Emit, and a reset signal line Vref are arranged in the display panel, and each signal line uses a same label as the signal it provides. Data shown in FIG. 7 is a data transmission line for transmitting a data signal Data.

The strobe signal S1 and the strobe signal S2 need to be provided by the shift driving circuit, and the light-emitting control signal Emit also needs to be provided by the shift driving circuit. In some embodiments, the strobe signal S1 and the strobe signal S2 required by one pixel circuit are provided by two shift register units cascaded in one driving circuit, and the light-emitting control signal Emit is provided by a shift register unit in another driving circuit. In some other embodiments, the strobe signal S1 and the strobe signal S2 required by one pixel circuit are respectively provided by shift register units in two driving circuits, and the light-emitting control signal Emit is provided by a shift register unit in another driving circuit.

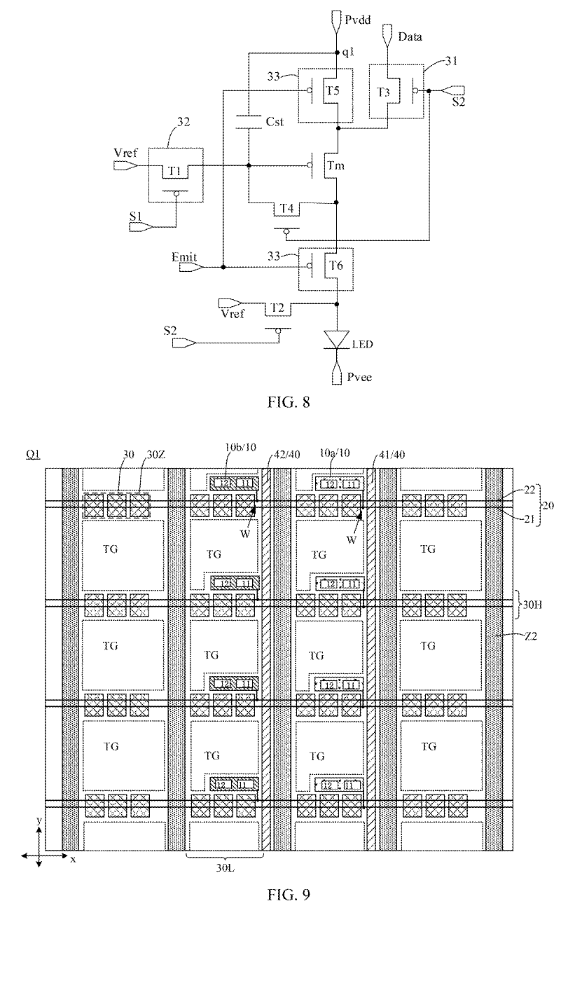

In some embodiments, FIG. 9 is a schematic diagram of another display panel according to an embodiment of the present disclosure. As shown in FIG. 9, n pixel circuits 30 arranged in the first direction x form a circuit group 30Z, where n is an integer and n≥2. FIG. 9 illustrates that n=3, and a second tracing region Z2 extending in the second direction y separates adjacent circuit groups 30Z. The display panel is provided with a driving signal line 40 extending in the second direction y. The second direction y intersects with the first direction x. The shift register unit 10 is connected to the driving signal line 40. In the first region Q1, the shift register unit 10 is adjacent to the circuit group 30Z in the second direction y, the driving signal line 40 is located at a side of the circuit group 30Z in the first direction x, the shift register unit 10 includes a driving module 11 and an output module 12, and the driving module 11 is located at a side of the output module 12 close to the driving signal line 40. Such an arrangement can facilitate the connection between the driving module 11 and the driving signal line 40, reduce winding, save wiring space, and minimize an influence on the transmission region TG caused by arranging the shift register unit 10 in the display region.

In the embodiment of FIG. 9, the shift register unit 10 includes a first shift register unit 10a and a second shift register unit 10b. The scan line 20 includes a first scan line 21 and a second scan line 22. A site W on the first scan line 21 is connected to an output terminal of the first shift register unit 10a. A site W on the second scan line 22 is connected to an output terminal of the second shift register unit 10b. The pixel circuits in the circuit group 30Z are connected to the first scan line 21 and the second scan line 22. As shown in FIG. 4, the first scan line 21 and the second scan line 22 are arranged in the first tracing region Z1. In this embodiment of the present disclosure, a plurality of first shift register units 10a arranged in the second direction y are cascaded, and a plurality of second shift register units 10b arranged in the second direction y are cascaded. The first shift register unit 10a and the second shift register unit 10b provide different scan signals.

In an embodiment, the first shift register unit 10a provides a light-emitting control signal Emit required by the pixel circuit, and the second shift register unit 10b provides a strobe signal S1 and/or a strobe signal S2 required by the pixel circuit.

In FIG. 9, the driving signal line 40 is located at a right side of the shift register unit 10 connected to the driving signal line 40. In another embodiment, the driving signal line 40 may also be disposed at a left side of the shift register unit 10 connected to the driving signal line 40 by adjusting the relative positions of the driving module 11 and the output module 12 in the shift register unit 10.

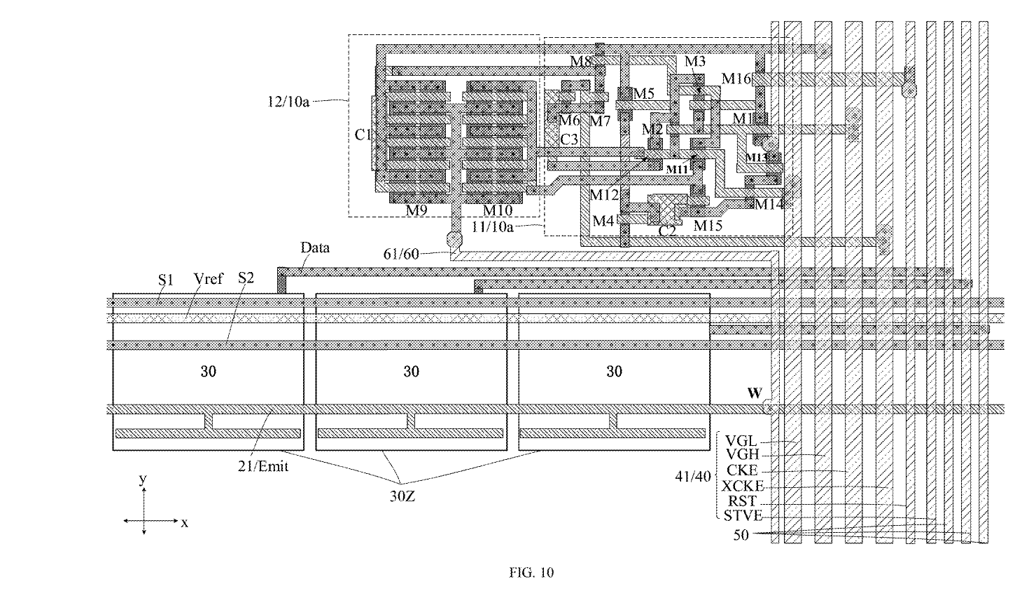

FIG. 10 is a partial schematic diagram of another display panel according to an embodiment of the present disclosure, and FIG. 10 illustrates a partial position of a first shift register unit 10a. FIG. 11 is a schematic diagram of a shift register unit according to an embodiment of the present disclosure. FIG. 10 simplifies the structure of the pixel circuit 30 at the position of the circuit group 30Z, the pixel circuit 30 may refer to FIG. 7. In addition, FIG. 10 illustrates a strobe line S1, a strobe line S2, a light-emitting control line Emit, a reset signal line Vref, and a data transmission line Data extending along the first direction x.

Referring to FIG. 10 and FIG. 11, the first shift register unit 10a includes sixteen transistors M1 to M16, and three capacitors C1, C2 and C3. The ninth transistor M9 and the tenth transistor M10 constitute the output module 12, and the other transistors constitute the driving module 11. In FIG. 11, nodes N1 to N7, an input terminal IN and an output terminal OUT in the shift register unit are also marked. The driving signal line 40 in the display panel includes a first driving signal line 41. The first driving signal line 41 includes a first voltage signal line VGL, a second voltage signal line VGH, a first clock signal line CKE, a second clock signal line CK2, a reset signal line RST, and a first start signal line STVE. An input terminal IN of the 1^{st} first shift register unit 10a is connected to a start signal line STVE, an input terminal IN of an i-th first shift register unit 10a is connected to an output terminal OUT of an (i-1)-th first shift register unit 10a, where i is an integer and i≥2.

It can be seen from FIG. 10 that the first shift register unit 10a includes a driving module 11 and an output module 12. The driving module 11 is located at a side of the output module 12 close to the first driving signal line 41. A connection line 60 is arranged in the display panel. The connection line 60 includes a first connection line 61. An output terminal of the first shift register unit 10a is connected to the site W on the light-emitting control line Emit through the first connection line 61. The light-emitting control line Emit is a first scan line 21 connected to the first shift register unit 10a.

In some embodiments of the present disclosure, the output terminal of the shift register unit 10 is connected to the site W on the scan line 20 through the connection line 60. The connection line 60 and the driving signal line 40 connected to the shift register unit 10 are located in a same layer. As shown in FIG. 10, the output terminal of the first shift register unit 10a is connected to the site W on the light-emitting control line Emit through the first connection line 61. The first connection line 61 and the first driving signal line 41 are located at a same side of the circuit group 30Z in the first direction x. The first connection line 61 and the first driving signal line 41 are located in a same layer. In the embodiments of the present disclosure, the positions of the connection line 60 and the driving signal line 41 can make the wiring in the panel denser, and the arrangement of the connection line 60 will not affect the wiring of the circuit group 30Z in the region of the shift register unit 10, resulting a same wiring manner of the circuit group 30Z at each position in the entire display region, and ensuring the etching uniformity in the manufacturing process.

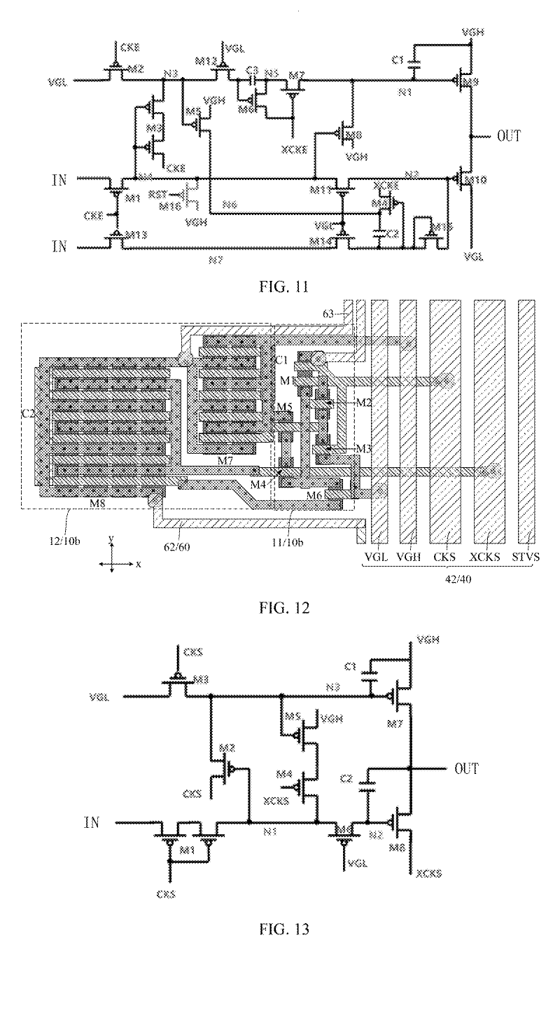

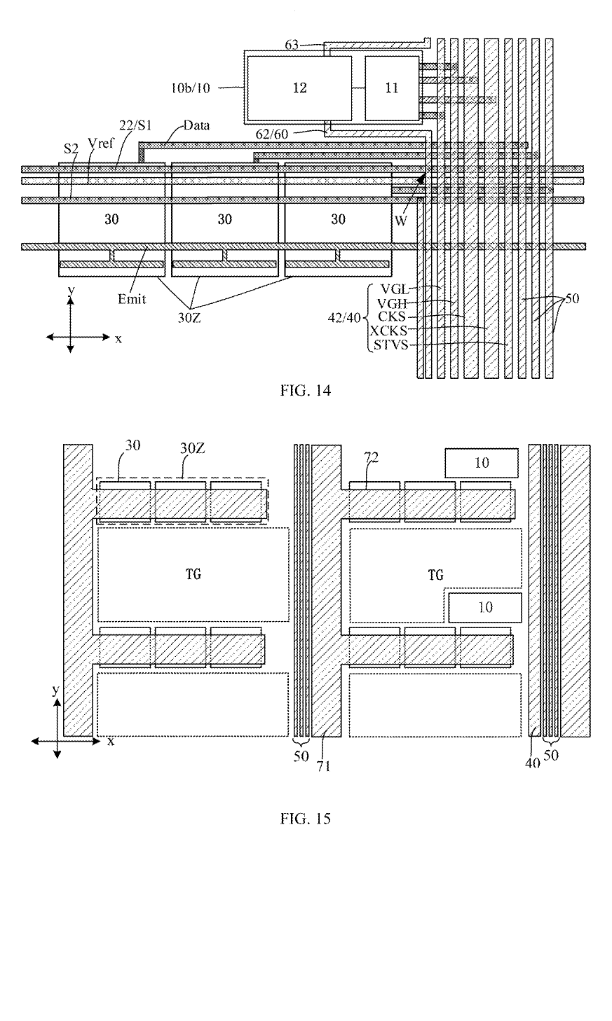

In some embodiments, FIG. 12 is a partial schematic diagram of another display panel according to an embodiment of the present disclosure, and FIG. 13 is a schematic diagram of a shift register unit according to an embodiment of the present disclosure. FIG. 12 illustrates a position of the second shift register unit 10b. FIG. 14 is a partial schematic diagram of another display panel according to an embodiment of the present disclosure. Positions of the circuit group 30Z and the second shift register unit 10b are simplified in FIG. 14, which may be understood with reference to FIG. 7 and FIG. 12.

Referring to FIG. 12 and FIG. 13, the second shift register unit 10b includes eight transistors M1 to M8, and two capacitors C1 and C2. The driving module 11 includes a first transistor M1 to a sixth transistor M6. The output module 12 includes a seventh transistor M7 and an eighth transistor M8. In FIG. 12, nodes N1 to N3, an input terminal IN and an output terminal OUT in the shift register unit are also marked. The driving signal line 40 in the display panel includes a second driving signal line 42. The second driving signal line 42 includes a first voltage signal line VGL, a second voltage signal line VGH, a third clock signal line CKS, a fourth clock signal line XCKS, and a second start signal line STVS. An input terminal IN of the 1^{st} second shift register unit 10b is connected to a start signal line STVS, an input terminal IN of an i-th second shift register unit 10b is connected to an output terminal OUT of an (i-1)-th second shift register unit 10b, where i is an integer and i≥2.

It can be seen from FIG. 14 that the second shift register unit 10b includes a driving module 11 and an output module 12. The driving module 11 is located at a side of the output module 12 close to the second driving signal line 42. A connection line 60 is arranged in the display panel. The connection line 60 includes a second connection line 62. An output terminal of the second shift register unit 10b is connected to a site W on the strobe line S1 through the second connection line 62. The strobe line S1 is a second scan line 22 connected to the second shift register unit 10b. The second connection line 62 and the second driving signal line 42 are located at a same side of the circuit group 30Z. The second connection line 62 and the second driving signal line 42 are located at a same layer. In the embodiments of the present disclosure, the positions of the second connection line 62 and the second driving signal line 42 can make the wiring in the panel denser, and the arrangement of the connection line 60 will not affect the wiring of the circuit group 30Z in the region of the shift register unit 10, resulting a same wiring manner of the circuit group 30Z at each position in the entire display region, and ensuring the etching uniformity in the manufacturing process.

When the strobe signal S1 and the strobe signal S2 of the pixel circuit are respectively provided by two second shift register units 10b in a group of driving circuits, referring to FIG. 12 and FIG. 14, a third connection line 63 is further arranged in the display panel. The third connection line 63 is led out from the output terminal of the second shift register unit 10b and connected to the strobe line S2 corresponding to the pixel circuit in a previous pixel circuit row. That is, one second shift register unit 10b provides the strobe signal S1 to the strobe line S1 corresponding to a pixel circuit row of the second shift register unit 10b and provides the strobe signal S2 to the strobe line S2 corresponding to the previous pixel circuit row.

In some embodiments, as shown in FIG. 10 and FIG. 14, the display panel includes a plurality of data lines 50 extending along the second direction y. One pixel circuit 30 in the circuit group 30Z is connected to one data line 50. In an example, the pixel circuit 30 is connected to the corresponding data line 50 through the data transmission line Data. The n data lines 50 connected to the circuit group 30Z are located at a same side of the circuit group 30Z in the first direction x. At a position of the shift register unit 10, the n data lines 50 are located at a side of the driving signal line 40 away from the circuit group 30Z connected thereto. Referring to FIG. 9, the circuit group 30Z is provided with the second tracing region Z2 at two sides of the first direction x. However, the second tracing region Z2 is provided with not only the data line 50 but also other signal line such as the power line. In the embodiments of the present disclosure, the n data lines 50 connected to the circuit group 30Z are located at a same side of the circuit group 30Z in the first direction x. When some power supply structure is formed in a same layer as the data line 50, an appropriate power supply structure is arranged at another side opposite to the data line 50 to drive the pixel circuit 30. In addition, at the position of the shift register unit 10, the n data lines 50 are disposed away from the circuit group 30Z connected to the data line 50 compared with the driving signal line 40, so that when connected to the shift register unit 10, the driving signal line 40 does not need to cross the data line 50, which can prevent a coupling effect between the data line 50 and the clock signal line among the driving signal line 40, thus avoiding an adverse impact on the circuit performance.

In FIG. 14, a same hatching pattern represents a same film layer. As can be seen from FIG. 14, the driving signal line 40 and the data line 50 are located in a same layer. In the embodiments of the present disclosure, the driving signal line 40 and the data line 50 are arranged in a same layer, which can reasonably and fully utilize the film layer of the data line 50. In addition, the driving signal line 40 and the data line 50 are located at a same side of the circuit group 30Z. When some power supply structure and the data line 50 are formed in a same layer, the data line 50 and the power supply structure can be arranged at two sides (i.e., a left side and a right side) of the circuit group 30Z respectively, to drive the pixel circuit 30.

In some embodiments, FIG. 15 is a schematic diagram of another display panel according to an embodiment of the present disclosure. FIG. 15 schematically shows a partial film layer structure in the display panel and illustrates the regions where 2×2 circuit groups 30Z are located. As shown in FIG. 15, the display panel includes a first power line 71 extending along the second direction y and a first power electrode 72 extending along the first direction x. The first power line 71, the first power electrode 72, and the data line 50 are located in a same layer. The first power line 71 and the n data lines 50 are respectively located at two sides of the circuit group 30Z. The first power electrode 72 is connected to the first power line 71 at an end away from the n data lines 50, where n=3 in FIG. 15. FIG. 15 is a top view of the display panel, and it can be understood that a top view direction is the same as a direction perpendicular to a substrate of the display panel. As shown in FIG. 15, the first power electrode 72 overlaps with and is electrically connected to the circuit group 30Z along the direction perpendicular to the plane of the substrate. Referring to FIG. 7, the first power electrode 72 is connected to a node q1 in the pixel circuit 30 through a through-hole penetrating the insulating layer, so as to provide the first power signal Pvdd to the pixel circuit 30.

In the embodiments of the present disclosure, the first power line 71, the first power electrode 72, and the data line 50 are located in a same layer, and the first power line 71 and the n data lines 50 connected to the circuit group 30Z are respectively disposed at two sides of the circuit group 30Z. Such an arrangement can enable full and reasonable utilization of the film layer of the data lines 50 and ensure that each pixel circuit 30 in the circuit group 30Z can receive the first power signal Pvdd provided by the first power line 71 through the first power electrode 72.

In addition, referring to FIG. 7, a first plate B1 of the storage capacitor Cst in the pixel circuit 30 is connected to the node q1, that is, the first plate B1 receives the first power signal Pvdd. Three first plates B1 in the circuit group 30Z are arranged to be connected to each other to form the auxiliary power line 71F extending along the first direction x. An extension direction of the auxiliary power line 71F intersects with an extension direction of the first power line 71 in FIG. 15, and the auxiliary power line 71F and the first power line 71 transmit a same signal, thereby forming a grid-like power line and reducing a voltage drop of the first power signal Pvdd.

In some other embodiments, FIG. 16 is a schematic diagram of another display panel according to an embodiment of the present disclosure, and FIG. 16 further illustrates a second power line in the display panel based on the embodiment of FIG. 15. As shown in FIG. 16, the display panel further includes a second power line 73 extending along the second direction y and a second auxiliary power line 73F extending along the first direction x. The second power line 73 intersects with and is electrically connected to the second auxiliary power line 73F for transmitting the second power signal Pvee. The second power line 73 and the second auxiliary power line 73F are located in a same layer, and the film layer of the second power line 73 is located at a side of the film layer of the first power line 71 away from the substrate. A connection electrode 74 is further disposed at the film layer of the second power line 73. The connection electrode 74 serves as an anode. Part of the second auxiliary power line 73F serves as a cathode. The light-emitting device is correspondingly connected to the anode and the cathode. Referring to FIG. 7, which illustrates a node q2. The node q2 in the pixel circuit is connected to the connection electrode 74 through a through-hole penetrating through the insulating layer, to supply power to the connection electrode 74.

Referring to FIG. 9 and FIG. 17, at least the data line 50, the second power line 73 and the first power line 71 are disposed in the second tracing region Q2 extending along the second direction y.

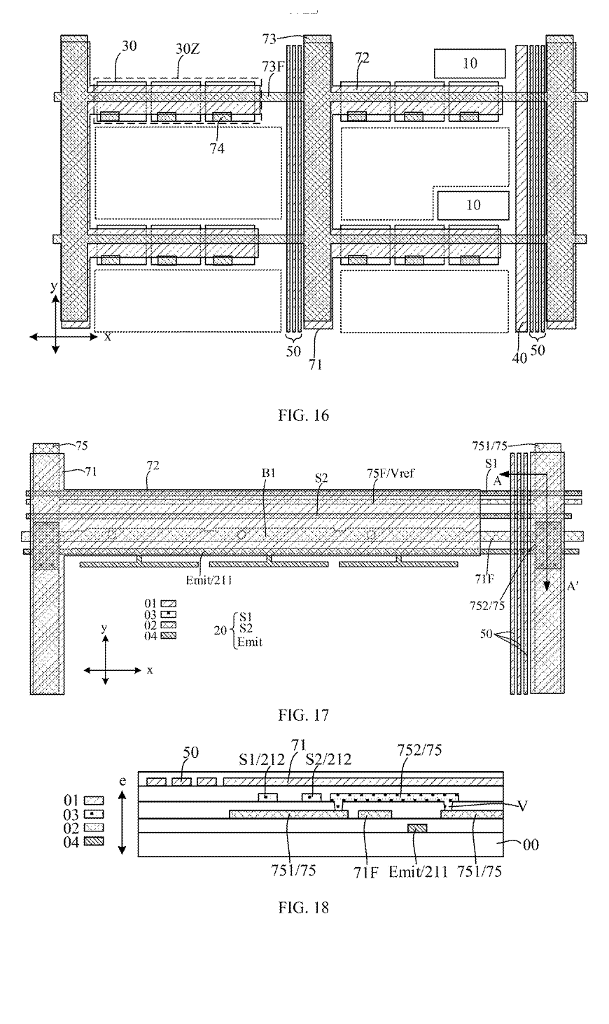

In some other embodiments, FIG. 17 is a schematic diagram of another display panel according to an embodiment of the present disclosure, and FIG. 18 is a cross-sectional schematic diagram along A-A′ shown in FIG. 17. FIG. 17 shows a region of one circuit group. FIG. 17 only illustrates each signal line extending in the first direction x across the region of the pixel circuit 30 without illustrating the pixel circuit 30. As shown in FIG. 17, the display panel includes a reset signal line 75 extending in the second direction y and an auxiliary reset line 75F extending in the first direction x. The auxiliary reset line 75F intersects with and is electrically connected to the reset signal line 75 for supplying the reset signal Vref. The pixel circuit 30 is electrically connected to the auxiliary reset line 75F. The auxiliary reset line 75F and the reset signal line 75 are located in a same layer. The signal line extending in the first direction x include a strobe line S1, a strobe line S2, a light-emitting control line Emit, a reset signal line Vref (i.e., an auxiliary reset line 75F), and an auxiliary power line 71F.

Referring to FIG. 17 and FIG. 18, along a direction e perpendicular to a plane of the substrate 00, the reset signal line 75 at least partially overlaps with the first power line 71. As shown in FIG. 18, the display panel includes a first metal layer 01 and a second metal layer 02 located at a side of the substrate 00. The first metal layer 01 is located at a side of the second metal layer 02 away from the substrate 00. The first power line 71 is located in the first metal layer 01. At least part of the reset signal line 75 is located in the second metal layer 02.

In an embodiment of the present disclosure, the auxiliary reset line 75F and the reset signal line 75 are arranged to intersect with and be electrically connected to each other to form the grid-like trace, which can reduce a voltage drop for transmitting reset signal and improve the display uniformity. The reset signal line 75 and the first power line 71 having a same extension direction are located in different layers and at least partially overlap with each other, which can save the space occupied by the wiring in the first direction x and improve the resolution.

Referring to FIG. 9 and FIG. 17, at least the data line 50, the reset signal line 75 and the first power line 71 are disposed in the second tracing region Q2 extending along the second direction y.

In some embodiments, as shown in FIG. 17 and FIG. 18, the display panel further includes a third metal layer 03. The third metal layer 03 is located between the second metal layer 02 and the first metal layer 01. The reset signal line 75 includes a first line segment 751 and a second line segment 752. The first line segment 751 is located in the second metal layer 02. The second line segment 752 is located in the third metal layer 03. Each of two ends of the second line segment 752 is respectively connected to one first line segment 751. In an example, the second line segment 752 is connected to the first line segment 751 through a through-hole V penetrating the insulating layer. The second line segment 752 is a bridge connection line between two first line segments 751.

As shown in FIG. 7, the pixel circuit 30 includes a storage capacitor Cst. The storage capacitor Cst includes a first plate. The position of the first plate B1 is marked in FIG. 17. A plurality of first plates B1 in the pixel circuit row are connected to each other to form the auxiliary power line 71F. The auxiliary power line 71F is located in the second metal layer 02. As can be seen from FIG. 18, along the direction e perpendicular to the plane of the substrate 00, the auxiliary power line 71F and the second line segment 752 intersect with and are insulated from each other. In an embodiment of the present disclosure, the auxiliary power line 71F and the first power line 71 are arranged to intersect with and be electrically connected to each other to form the grid-like trace, which can reduce a voltage drop for transmitting the first power signal and improve the display uniformity. When the wiring requirement of the auxiliary power line 71F is satisfied, the structure of the reset signal line 75 is further designed. At the intersection position of the reset signal line 75 and the auxiliary power line 71F, the reset signal line 75 adopts the design of bridge switching, which can avoid a short circuit between the reset signal line 75 and the auxiliary power line 71F.

In some embodiments, as shown in FIG. 17 and FIG. 18, the display panel includes a fourth metal layer 04. The fourth metal layer 04 is located at a side of the second metal layer 02 close to the substrate 00. The scan line 20 includes at least one first scan sub-line 211. The first scan sub-line 211 is located in the fourth metal layer 04. The first scan sub-line 211 includes a light-emitting control line Emit. Along the direction perpendicular to the plane of the substrate, the first scan sub-line 211 and the second line segment 752 intersect with and are insulated from each other. Such an arrangement can increase a distance between the first scan sub-line 211 and the reset signal line 75, thereby reducing a parasitic capacitance between the first scan sub-line 211 and the reset signal line 75, thus being beneficial to improving the stability of the transmission of the scan signal.

In some embodiments, the second metal layer 02 and the fourth metal layer 04 are made of a same material including metal molybdenum.

In some embodiments, the first metal layer 01 and the third metal layer 03 are made of a same material including titanium and/or aluminum. In an embodiment, each of the first metal layer 01 and the third metal layer 03 is of a structure of titanium/aluminum/titanium.

In some embodiments, the display panel further includes a semiconductor layer and a light shielding layer. The semiconductor layer is located at a side of the fourth metal layer 04 close to the substrate 00. Channel and some connection lines of the transistors are located in the semiconductor layer The light shielding layer is located at a side of the semiconductor layer close to the substrate 00. The light shielding layer is configured to shield the channel of each transistor, thereby preventing light from reaching the channel to affect the performance of the transistor.

In the embodiment of FIG. 17, the reset signal line 75 adopts the design of bridge switching at the intersection position of the reset signal line 75 and the auxiliary power line 71F. In some other embodiments, the auxiliary power line 71F adopts a design of bridge switching at the intersection position of the reset signal line 75 and the auxiliary power line 71F. In some other embodiments, the reset signal line 75 and the auxiliary power line 71F are disposed in different metal layers, which will not be illustrated herein again.

As shown in FIG. 17, the display panel includes a scan line 20 extending along the first direction x. Each of the strobe line S1, the strobe line S2, and the light-emitting control line Emit may be the scan line 20. As can be seen from the top view of FIG. 17, along the direction perpendicular to the plane of the substrate, the scan line 20 and the reset signal line 7 intersect with and are insulated from each other.

Referring to FIG. 18, the display panel further includes a third metal layer 03 and a fourth metal layer 04. The third metal layer 03 is located between the second metal layer 02 and the first metal layer 01. The fourth metal layer 04 is located at a side of the second metal layer 02 close to the substrate 00. The scan line 20 includes at least one second scan sub-line 212 located in the third metal layer 03. As shown in FIG. 18, the second scan sub-line 212 includes a strobe line S1 and a strobe line S2.

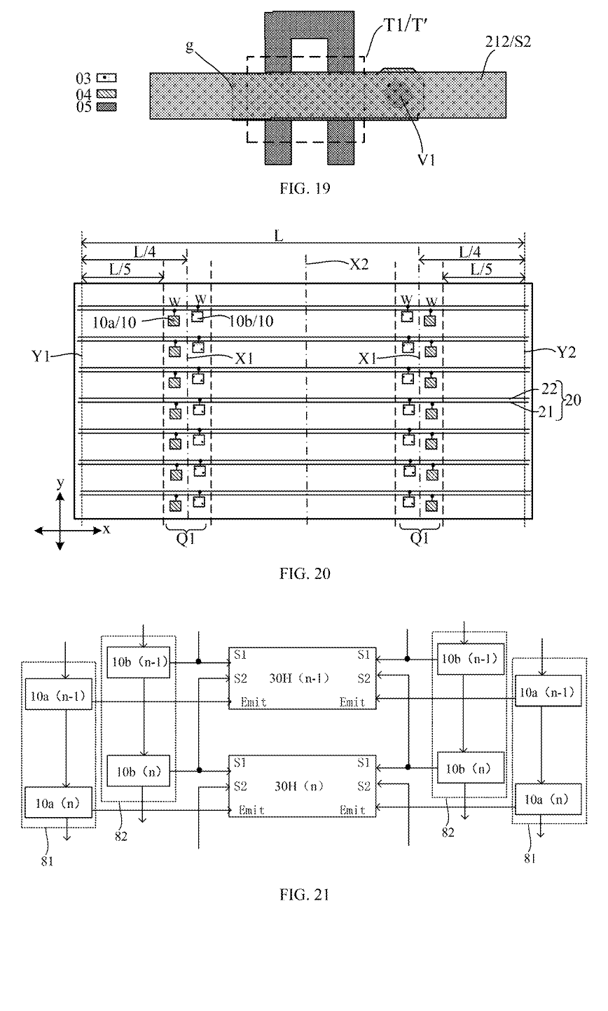

FIG. 19 is an enlarged schematic view of the region Q2 in FIG. 17 and illustrates a partial position of the strobe line S1. As shown in FIG. 19, the pixel circuit 30 includes a first transistor T′. A gate g of the first transistor T′ is located in the fourth metal layer 04. The gate g of the first transistor T′ is connected to the second scan sub-line 212 through a through-hole V1. A channel of the first transistor T′ is located in the semiconductor layer 05. The semiconductor layer 05 is located at a side of the fourth metal layer 04 close to the substrate. In this embodiment, the second scan sub-line 212 is disposed in the third metal layer 03, and the third metal layer 03 is made of a material used including metal aluminum and/or metal titanium, which can reduce the resistance of the second scan sub-line 212, thereby reducing a voltage drop during the transmission of the scan signal, minimizing the delay difference in receiving the scan signal at each position of the pixel circuit row, and improving the display uniformity.

In some embodiments, as shown in FIG. 9, the shift register unit 10 includes a first shift register unit 10a and a second shift register unit 10b. The scan line 20 includes a first scan line 21 and a second scan line 22. Two sites W on the first scan line 21 are connected to two first shift register units 10a, and two sites W on the second scan line 22 are connected to two second shift register units 10b. FIG. 9 illustrates the layout in the first region Q1. The driving signal line 40 includes a first driving signal line 41 and a second driving signal line 42. The first shift register unit 10a is connected to the first driving signal line 41. The second shift register unit 10b is connected to the second driving signal line 42. In the first region Q1, an arrangement of the first shift register unit 10a and the first driving signal line 41 is the same as an arrangement of the second shift register unit 10b and the second driving signal line 42. In FIG. 9, the driving signal line 40 is located at the right side of the shift register unit 10 connected thereto. In other embodiments, the driving signal line 40 may also be located at the left side of the shift register unit 10 connected thereto. When applied to transparent display, by adopting the design of this embodiment of the present disclosure, a width of the non-transmission region in the first region Q1 in the first direction x can be relatively regular, thereby avoiding the formation of a non-transmission region with a larger width between a circuit column of the first shift register unit 10a and a circuit column of the second shift register unit 10b to affect the transparent display effect.

As shown in FIG. 9, a plurality of circuit groups 30Z are arranged in a circuit column 30L in the second direction y. In the first region Q1, a circuit column 30L corresponding to the first shift register unit 10a is adjacent to a circuit column 30L corresponding to the second shift register unit 10b. With reference to the related description of the embodiment of FIG. 2, an arrangement of the circuit column 30L correspond to each of the first shift register unit 10a and the second shift register unit 10b in the embodiment of FIG. 9 can facilitate the arrangement of both the first shift register unit 10a and the second shift register unit 10b near the first virtual line X1, which can balance a delay difference of the scan signals at different positions of the first scan line 21 in the first direction x and a delay difference of the scan signals at different positions of the second scan line 22 in the first direction x, thereby improving the display uniformity.

In some embodiments, as shown in FIG. 9, the shift register unit 10 includes a first shift register unit 10a and a second shift register unit 10b. The scan line 20 includes a first scan line 21 and a second scan line 22. Two sites W on the first scan line 21 are connected to two first shift register units 10a, and two sites W on the second scan line 22 are connected to two second shift register units 10b. FIG. 9 only illustrates the layout in one first region Q1. At the position of a same pixel circuit row 30H in the first region Q1, the first shift register unit 10a and the second shift register unit 10b are located at a same side of the circuit group 30Z in the second direction y. Such an arrangement enables a shape of a transmission region TG in the circuit column 30L of the first shift register unit 10a to be substantially same as a shape of a transmission region TG in the circuit column 30L of the second shift register unit 10b. Moreover, the more regular shape of the transmission region TG can ensure the display effect of the transparent display.

In some embodiments, FIG. 20 is a schematic diagram of another display panel according to an embodiment of the present disclosure, as shown in FIG. 20, the shift register unit 10 includes a first shift register unit 10a and a second shift register unit 10b. The scan line 20 includes a first scan line 21 and a second scan line 22. Two sites W on the first scan line 21 are connected to two first shift register units 10a, and two sites W on the second scan line 22 are connected to two second shift register units 10b. The display panel includes a first virtual line X1 and a second virtual line X2 extending in the second direction y. The second direction y intersects with the first direction x. The pixel circuit row (not shown in FIG. 20) includes a first edge Y1 and a second edge Y2 opposite to each other in the first direction x. In the first direction x, a distance between the first virtual line X1 and an edge of the pixel circuit row is L/4. The second virtual line X2 has a same distance from two edges of the pixel circuit row. Each of two first regions Q1 respectively has one first virtual line X1. In each of the two first regions Q1, the first shift register unit 10a and the second shift register unit 10b are respectively located at two sides of the first virtual line X1. In this embodiment, the second virtual line X2 is equivalent to a center line of the display panel, and two first virtual lines X1 are equivalent to a 1/4 division line and a 3/4 division line of the display panel in the first direction x. The first shift register unit 10a and the second shift register unit 10b are both disposed near the first virtual line X1, which can balance the delay difference of the scan signals at different positions of the first scan line 21 in the first direction x and the delay difference of the scan signals at different positions of the second scan line 22 in the first direction x, thereby improving the display uniformity.

Further, as shown in FIG. 20, two groups of second shift register units 10b located in the two first regions Q1 are disposed between the two first virtual lines X1. The first shift register unit 10a in one first region Q1 is located between the first virtual line X1 and the first edge Y1. The first shift register unit 10a in the other first region Q1 is located between the first virtual line X1 and the second edge Y2. Such an arrangement enables the first shift register units 10a in the two first regions Q1 to be symmetrical with respect to the second virtual line X2, and the second shift register units 10b in the two first regions Q1 to be symmetrical with respect to the second virtual line X2, which is beneficial for enabling the two sites W1 on the first scan line 21 to be symmetrical with respect to the second virtual line X2, and enabling the two sites W1 on the second scan line 22 to be symmetrical with respect to the second virtual line X2, thereby further alleviating the delay difference of the scan signals at different positions on the first scan line 21 and the delay difference of the scan signals at different positions on the second scan line 22, and thus improving the display uniformity.

FIG. 21 is a schematic diagram of driving a display panel according to an embodiment of the present disclosure. As shown in FIG. 21, a strobe signal S1, a strobe signal S2 and a light-emitting control signal Emit are required for driving the pixel circuit row 30H. A plurality of first shift register units 10a form a first driving circuit 81. A plurality of cascaded second shift register units 10b form a second driving circuit 82. The first driving circuit 81 is configured to provide the light-emitting control signal Emit required by the pixel circuit. The second driving circuit 82 is configured to provide the strobe signal S1 and the strobe signal S2 required by the pixel circuit. Referring to the pixel circuit shown in FIG. 8, the first light-emitting control transistor T5 and the second light-emitting control transistor T6 in the pixel circuit are connected to the first shift register unit 10a in the first driving circuit 81. The data writing transistor T3 and the gate reset transistor T1 are correspondingly connected to the second shift register unit 10b in the second driving circuit 82. FIG. 21 illustrates driving conditions of a n-th pixel circuit row 30H(n) and a (n-1)-th pixel circuit row 30H, where n is an integer and n≥2. An output terminal of the n-th first shift register unit 10a(n) is connected to the scan line to provide the light-emitting control signal Emit to the n-th pixel circuit row 30H(n). An output terminal of the n-th second shift register unit 10b(n) is connected to one scan line to provide the strobe signal S1 to the n-th pixel circuit row 30H (n), and simultaneously connected to the another scan line to provide the strobe signal S2 to the (n-1)-th pixel circuit row 30H(n-1). The first driving circuit 81 and the second driving circuit 82 are disposed in each of the two first regions Q1 of the display panel.

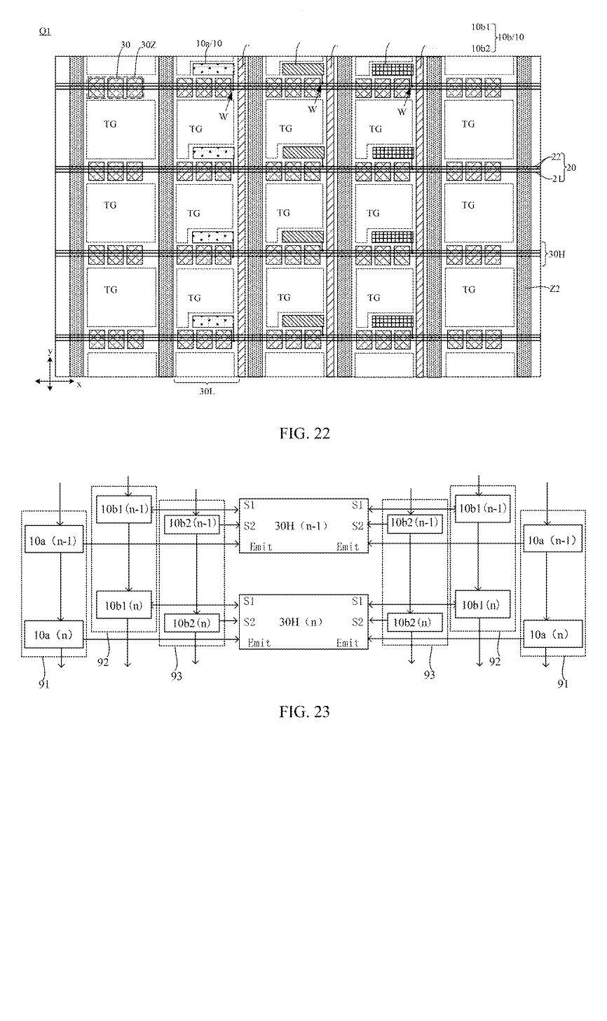

In some embodiments, FIG. 22 is a schematic diagram of another display panel according to an embodiment of the present disclosure, and FIG. 23 is a schematic diagram of driving another display panel according to an embodiment of the present disclosure. As shown in FIG. 22, the shift register unit 10 includes a first shift register unit 10a and a second shift register unit 10b. The scan line 20 includes a first scan line 21 and a second scan line 22. One site W1 on the scan line 20 is located in one first region Q1. Two sites W on the first scan line 21 are connected to two first shift register units 10. Two sites W on the second scan line 22 are connected to two second shift register units 10. FIG. 22 illustrates a partial position of one first region Q1 in the display panel. The second shift register unit 10b includes a first gate shift register unit 10b1 and a second gate shift register unit 10b2. The first gate shift register unit 10b1 and the second gate shift register unit 10b2 are respectively connected to respective second scan line 22.

Referring to FIG. 8, the pixel circuit 30 includes a data writing module 31, a gate reset module 32 and a light-emitting control module 33. The data writing module 31 includes a data writing transistor T3. The gate reset module 32 includes a gate reset transistor T1. The light-emitting control module 33 includes a first light-emitting control transistor T5 and a second light-emitting control transistor T6. The second scan line 22 connected to the first gate shift register unit 10b1 is connected to the gate reset module 32. The second scan line 22 connected to the second gate shift register unit 10b1 is connected to the data writing module 31. The first scan line 21 connected to the first shift register unit 10a is connected to the light-emitting control module 33. That is, the second scan line 22 connected to the first gate shift register unit 10b1 provides the strobe signal S1 required by the pixel circuit 30. The second scan line 22 connected to the second gate shift register unit 10b1 provides the strobe signal S2 required by the pixel circuit 30. The first scan line 21 connected to the first shift register unit 10a provides the light-emitting control signal Emit required by the pixel circuit 30.

As shown in FIG. 23, a plurality of first shift register units 10a form a first driving circuit 91. A plurality of cascaded first gate shift register units 10b1 form a second driving circuit 92. A plurality of cascaded second gate shift register units 10b2 form a third driving circuit 93. The first driving circuit 91 is configured to provide the light-emitting control signal Emit required by the pixel circuit. The second driving circuit 92 is configured to provide the strobe signal S1 required by the pixel circuit. The third driving circuit 93 is configured to provide the strobe signal S2 required by the pixel circuit. With reference to the pixel circuit shown in FIG. 8, the light-emitting control circuit 33 in the pixel circuit is connected to the first shift register unit 10a in the first driving circuit 91. The gate reset circuit 32 is connected to the first gate shift register unit 10b1 in the second driving circuit 92. The data writing circuit 31 is connected to the second gate shift register unit 10b2 in the third driving circuit 93. FIG. 23 illustrates driving conditions of a n-th pixel circuit row 30H(n) and a (n-1)-th pixel circuit row 30H, where n is an integer and n≥2. An output terminal of the n-th first shift register unit 10a(n) is connected to the first scan line to provide the light-emitting control signal Emit to the n-th pixel circuit row 30H(n). An output terminal of the n-th first gate shift register unit 10b1 is connected to one second scan line to provide the strobe signal S1 to the n-th pixel circuit row 30H(n). An output terminal of the n-th second gate shift register unit 10b2 is connected to another second scan line to provide the strobe signal S2 to the n-th pixel circuit row 30H(n). The first driving circuit 91, the second driving circuit 92 and the third driving circuit 93 are disposed in each of the two first regions Q1 of the display panel.

In an embodiment of the present disclosure, the data writing module 31 and the gate reset module 32 in the pixel circuit are provided with strobe signals by respective shift register units, which can increase the driving capability and meet the driving requirements of a large-size display screen.

In the embodiment of FIG. 22, for the first gate shift register unit 10b1 and the second gate shift register unit 10b2, one shift register unit drives one pixel circuit row 30H. The layout at the respective positions of the first gate shift register unit 10b1 and the second gate shift register unit 10b2 may refer to the design in FIG. 12, with the difference that neither the first gate shift register unit 10b1 nor the second gate shift register unit 10b2 requires for the third connection lines 63 in the embodiment of FIG. 22.

The relevant embodiments mentioned above illustrate a pixel circuit 30, which includes 7 transistors and 1 capacitor. When driving the pixel circuit 30, either the first shift register unit 10a and the second shift register unit 10b as in the embodiment of FIG. 20 may be arranged in the first region Q1, or the first shift register unit 10a, the first gate shift register unit 10b1, and the second gate shift register unit 10b2 as in the embodiment of FIG. 22 may be arranged in the first region Q1.

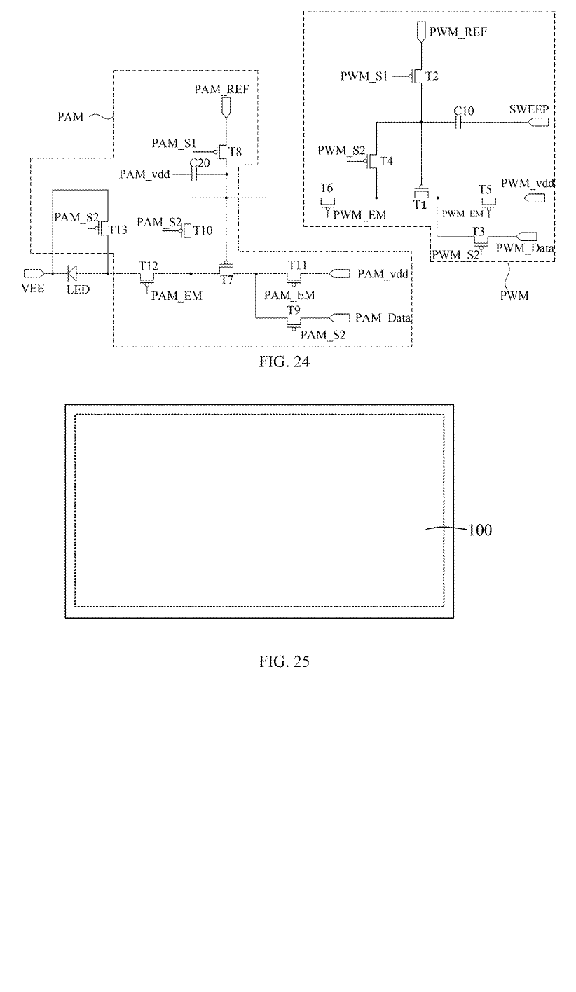

The pixel circuit in the embodiment o0f the present disclosure may also have other structure. FIG. 24 is a schematic diagram of another pixel circuit according to an embodiment of the present disclosure. As shown in FIG. 24, the pixel circuit includes a first circuit PAM, and a second circuit PWM. The first circuit PAM is configured to control an amplitude of a driving current provided to a sub-pixel based on a first data voltage PAM-Data. The second circuit PWM is configured to control a duration of a driving current provided to the sub-pixel based on a second data voltage PWM-Data. The sub-pixel includes a light-emitting device LED.

The first circuit PAM includes a first driving transistor T7, a first gate reset transistor T8, a first data writing transistor T9, a first compensation transistor T10, a first control transistor T11, a second control transistor T12, an electrode reset transistor T13, and a first storage capacitor C20. The first storage capacitor C20 is a storage capacitor in the first circuit PAM. The first driving transistor T7 is connected in series between the first control transistor T11 and the second control transistor T12. The first control transistor T11 is connected between the first power supply voltage PAM-vdd and a first electrode of the second driving transistor T7. The second control transistor T12 is connected between a second electrode of the first driving transistor T7 and the light-emitting device LED. The first driving transistor T7 is configured to generate a driving current under control of its gate voltage. The first data writing transistor T9 is connected to the first electrode of the first driving transistor T7. The first compensation transistor T10 is connected to the second electrode of the first driving transistor T7 and a control terminal. The first gate reset transistor T8 is connected to the control terminal (i.e., the gate) of the first driving transistor T7. A first plate of the first storage capacitor C20 is connected to the gate of the first driving transistor T7. A second plate of the first storage capacitor C20 is connected to the first power supply voltage PAM-vdd. The electrode reset transistor T13 is connected to a first plate of the light-emitting device LED. The second control transistor T12 is also connected to the first plate of the light-emitting device LED. The second electrode of the light-emitting device LED is connected to a third power supply voltage VEE. A gate of the first gate reset transistor T8 is connected to the first scan signal PAM-S1. Gates of the first data write transistor T9, the first compensation transistor T10, and the electrode reset transistor T13 are connected to a second scan signal PAM-S2. A control terminal of the first control transistor T11 and/or a control terminal of the second control transistor T12 receive a first control signal PAM-EM. In addition, FIG. 5 illustrates that a first terminal of the electrode reset transistor T13 receives the third power supply voltage VEE, and a second terminal of the electrode reset transistor T13 is connected to the first plate of the light-emitting device LED. In some other embodiments, the first terminal of the electrode reset transistor T13 may receive a reset signal PAM-REF or receive a constant voltage signal PAM-INIT.

The second circuit PWM includes a second driving transistor T1, a second gate reset transistor T2, a second data writing transistor T3, a second compensation transistor T4, a third control transistor T5, a fourth control transistor T6 and a second storage capacitor C10. The third control transistor T5 is connected between a second supply voltage PWM-vdd and a first electrode of the second driving transistor T1. The fourth control transistor T6 is connected between a second electrode of the second driving transistor T1 and the gate of the first driving transistor T7. The second data writing transistor T3 is connected to the first electrode of the second driving transistor T1. The second compensation transistor T4 is connected to the second electrode of the second driving transistor T1 and the gate of the second driving transistor T1. The second gate reset transistor T2 is connected to the gate of the second driving transistor T1. One plate of the second storage capacitor C10 is connected to the second driving transistor T1, and the other plate of the second storage capacitor C10 receives a sweep signal SWEEP. A gate of the second gate reset transistor T2 is connected to a third scan signal PWM-S1. Gates of the second data writing transistor T3 and the second compensation transistor T4 are connected to a fourth scan signal PWM-S2. Gates of the third control transistor T5 and the fourth control transistor T6 are connected to a second control signal PWM-EM.

FIG. 24 illustrates that an output terminal of the second circuit PWM (i.e., an output terminal of the fourth control transistor T6) is connected to the gate of the first driving transistor T7. In another embodiment, the output terminal of the second circuit PWM is connected to the gate of the second control transistor T12, which will not be illustrated herein again. In another embodiment, a light-emitting duration control transistor is additionally provided in a light-emitting series circuit of the first circuit PAM. For example, a light-emitting duration control transistor is connected in series between the second control transistor T12 and the light-emitting device LED in FIG. 24, and an output terminal of the second circuit PWM is connected to a gate of the light-emitting duration control transistor.

When the display panel includes the pixel circuit in the embodiment of FIG. 24, a plurality of groups of shift driving circuits are arranged in the display panel, and at least include a first shift driving circuit providing a first scan signal PAM-S1, a second shift driving circuit providing a second scan signal PAM-S2, a third shift driving circuit providing a first control signal PAM-EM, a fourth shift driving circuit providing a third scan signal PWM-S1, a fifth shift driving circuit providing a fourth scan signal PWM-S2, and a sixth shift driving circuit providing a second control signal PWM-EM. In some embodiments, a seventh shift driving circuit providing the sweep signal SWEEP is further included. Each shift driving circuit includes a plurality of cascaded shift register units. The shift register unit in at least one of the above-mentioned shift driving circuits may adopt the design of the above-mentioned related embodiments.

At least one of the shift driving circuits for driving the pixel circuit in the embodiment of FIG. 24 adopts the design in the embodiment of FIG. 1, the shift register units 10 connected to a same type of scan line are arranged in the display regions at the left and right sides of the display panel. Two shift register units 10 are arranged to be correspondingly connected to two sites W on one scan line 20, and one site W is located in one first region Q1. The two sites W serve as two signal input sites on the scan line 20. Scan signals provided by the shift register unit 10 to the scan line 20 are transmitted to the left side and the right side respectively from the position of each of the two sites W. The arrangement of the two sites W and the regions of the two sites results in small delay differences of scan signals at two sides of the sites W, which can balance the delay differences of scan signals at different positions of the display panel in the first direction x and improve the display uniformity.

Further, the shift register unit 10 connected to the site W is disposed in the corresponding first region Q1, thereby reducing a distance between the output terminal of the shift register unit 10 and the site W connected thereto, reducing a voltage drop during the scan signal transmission, and also facilitating narrow design of the left and right frame of the display panel.

Further, as shown in FIG. 2, two shift register units 10 correspondingly connected to two sites W on the scan line 20 are located between two first virtual lines X1. Alternatively, as shown in FIG. 3, for two shift register units 10 correspondingly connected to the two sites W on one scan line 20, one of the two shift register units 10 is located between the first virtual line X1 and the first edge Y1, and the other one of the two shift register units 10 is located between the first virtual line X2 and the second edge Y2. The relative positions of the two shift register units 10 connected to a same scan line 20 in the two first regions Q1 with respect to the first virtual line X1 are designed, in such a manner that the two shift register units 10 in the two first regions Q1 are approximately symmetrical with respect to the second virtual line X2 (i.e., the center line of the display panel). Such an arrangement can further balance the delay differences of scan signals at different positions of the display panel in the first direction x, thereby improving the display uniformity.

In some embodiments, it may be configured that two sites W on the single scan line 20 have a same distance from the second virtual line X2, and two shift register units 10 correspondingly connected to the two sites W also have a same distance from the second virtual line X2. The two sites W on one scan line 20 are arranged to be symmetrical with respect to the second virtual line X2, and the two shift register units 20 corresponding to the two sites W are also symmetrical with respect to the second virtual line X2. In this way, the scan signals input at the two sites W on the scan line 20 are substantially the same, and the voltage drops of the scan signals on the left and right sides of the display panel in the first direction x are substantially the same, thereby improving the display uniformity.

In some embodiments, as shown in the design of FIG. 5, the shift register unit 10 is configured to include a drive module 11 and an output module 12 arranged the first direction x, and the driving modules 11 and the output modules 12 in the two first regions Q1 are arranged in a same order. As shown in the design of FIG. 6, the shift register unit 10 is also configured to include a drive module 11 and an output module 12 arranged in the first direction x, and the arrangement order of the driving modules 11 and the output modules 12 in the two first regions Q1 is in a mirror relationship.

In addition, when two or more than two types of shift register units are disposed in the one first region Q1, for example, the shift register unit providing the first scan signal PAM-S1 and the shift register unit providing the second scan signal PAM-S2 are two types of shift register units. Or as shown in the design of the embodiment in FIG. 9, arrangements of various shift register units and corresponding driving signal lines follows a same arrangement rule.

When two or more types of shift register units are disposed in one first region Q1, it can be seen that in the design of FIG. 9, at a position of a same pixel circuit row 30H in the first region Q1, various shift register units 10 are located at a same side of the circuit group 30Z in the second direction y.

It should be noted that the technical solutions involved in the embodiments of FIG. 1 to FIG. 23 may be applied to a display panel including the pixel circuit in the embodiment of FIG. 24 in any case of no conflicts.

Based on a same inventive concept, an embodiment of the present disclosure further provides a display device. FIG. 25 is a schematic diagram of a display device according to an embodiment of the present disclosure. As shown in FIG. 25, the display device includes the display panel provided by any embodiment of the present disclosure. The structure of the display panel has been described in the above-mentioned embodiments and will not be repeated herein. The display device provided by the embodiments of the present disclosure may be, for example, an electronic device having a display function, such as a mobile phone, a tablet, a computer, a television, and a smart wearable product. The display device provided by the embodiments of the present disclosure may also be a transparent display device, such as a transparent display window; or may also be a spliced display device, such as a large conference room screen, and a large exhibition hall screen.

What is claimed is:

1. A display panel, comprising shift register units, scan lines and pixel circuits, wherein
the pixel circuits are arranged in a pixel circuit row in a first direction, one of the scan lines extends along the first direction and is connected to the pixel circuits in the pixel circuit row, and a length of the pixel circuit row in the first direction is L;
a display region of the display panel comprises at least two first regions, wherein a width of one first region of the at least two first regions in the first direction is L/10, the pixel circuit row comprises a first edge and a second edge opposite to the first edge in the first direction, a minimum distance between the first edge and one of the at least two first regions is L/5, and a minimum distance between the second edge and another one first region of the at least two first regions is L/5; and
one scan line of the scan lines comprises two sites, one first region of the at least two first regions is provided with a respective one of the two sites, and one site of the two sites is correspondingly connected to an output terminal of a respective one shift register of the shift register units.

2. The display panel according to claim 1, wherein the shift register unit connected to one site of the two sites is located in a respective one first region of the at least two first regions corresponding thereto.

3. The display panel according to claim 2, wherein
the display panel comprises:
a first virtual line extending along a second direction, wherein the second direction intersects with the first direction;
in the first direction, a distance between the first virtual line and an edge of the pixel circuit row is L/4; and
each of two first regions corresponds to a respective one first virtual line, and
wherein two shift register units correspondingly connected to two sites are located between two first virtual lines; or
one of two shift register units correspondingly connected to two sites is located between the first virtual line and the first edge, and the other shift register of the two shift register units correspondingly connected to the two sites is located between the first virtual line and the second edge.

4. The display panel according to claim 2, wherein the display panel comprises:
a second virtual line extending along a second direction, wherein the second direction intersects with the first direction, and the first edge and the second edge have a same distance from the second virtual line; and
wherein two sites have a same distance from the second virtual line, and two shift register units correspondingly connected to two sites have a same distance from the second virtual line.

5. The display panel according to claim 2, wherein
one shift register unit of the shift register units comprises a driving module and an output module arranged in the first direction; and an arrangement order of the driving module and the output module in one first region of the two first regions is the same as an arrangement order of the driving module and the output module in the other one of the two first regions, or
one shift register unit of the shift register units comprises a driving module and an output module arranged in the first direction; and an arrangement order of the driving module and the output module in one first region of the two first regions and an arrangement order of the driving module and the output module in the other one first region of the two first regions are in a mirror relationship.

6. The display panel according to claim 2, wherein the display region comprises:
a transmission region;
a non-transmission region;
n pixel circuits arranged in the first direction form a circuit group, wherein n is an integer and n≥2; and
in one first region of the first regions, the shift register unit and the circuit group adjacent thereto in a second direction form a continuous non-transmission region, and the second direction intersects with the first direction.

7. The display panel according to claim 6, wherein the transmission region comprises:
a first transmission region;
a second transmission region, and wherein a length of the first transmission region in the first direction is smaller than a length of the second transmission region in the first direction; and
the display panel comprises a driving signal line extending along the second direction, wherein the shift register unit is connected to the driving signal line; and the driving signal line in the first region is adjacent to the first transmission region.

8. The display panel according to claim 2, wherein n pixel circuits arranged in the first direction form a circuit group, where n is an integer and n≥2;
the display panel comprises a driving signal line extending in a second direction, the second direction intersects with the first direction, and the shift register unit is connected to the driving signal line; and
in one first region of the first regions, the shift register unit is adjacent to the circuit group in the second direction, the driving signal line is located at a side of the circuit group in the first direction, the shift register unit comprises a driving module and an output module, and the driving module is located at a side of the output module close to the driving signal line.

9. The display panel according to claim 8, wherein an output terminal of the shift register unit is connected to the site through a connection line; and
the connection line and the driving signal line are located at a same side of the circuit group in the first direction, and the connection line and the driving signal line are located in a same layer.

10. The display panel according to claim 8, wherein the display panel comprises a plurality of data lines extending along the second direction, one pixel circuit in the circuit group is connected to one of the plurality of data lines, and n data lines connected to the circuit group are located at a same side of the circuit group in the first direction; and
at a position of the shift register unit, the n data lines are located at a side of the driving signal line away from the circuit group connected thereto.

11. The display panel according to claim 10, wherein the display panel further comprises a first power line extending along the second direction and a first power electrode extending along the first direction, and the first power line, the first power electrode and the data line are located in a same layer;
the display panel comprises a substrate, and in a direction perpendicular to a plane of the substrate, the first power electrode overlaps with and is electrically connected to the circuit group; and
the first power line and the n data lines are located at two sides of the circuit group, and the first power electrode is connected to the first power line at an end away from the n data lines.

12. The display panel according to claim 11, wherein the display panel further comprises a reset signal line extending along the second direction and an auxiliary reset line extending along the first direction, the auxiliary reset line intersects with and is electrically connected to the reset signal line; the pixel circuit is electrically connected to the auxiliary reset line, and in the direction perpendicular to the plane of the substrate, the reset signal line at least partially overlaps with the first power line;
the display panel comprises a first metal layer and a second metal layer that are located at a side of the substrate, and the first metal layer is located at a side of the second metal layer away from the substrate; and
the first power line is located in the first metal layer, and the auxiliary reset line and at least part of the reset signal line are located in the second metal layer.

13. The display panel according to claim 12, wherein the display panel further comprises a third metal layer located between the second metal layer and the first metal layer; the reset signal line comprises a first line segment and a second line segment, the first line segment is located in the second metal layer, the second line segment is located in the third metal layer, and each of two ends of the second line segment is connected to a respective one first line segment,
the pixel circuit comprises a storage capacitor, the storage capacitor comprises a first plate, a plurality of first plates in the pixel circuit row are connected to each other to form an auxiliary power line, and the auxiliary power line is located in the second metal layer; and in the direction perpendicular to the plane of the substrate, the auxiliary power line intersects with and is insulated from the second line segment;
and/or, the display panel comprises a fourth metal layer, the fourth metal layer is located at a side of the second metal layer close to the substrate, the scan line comprises at least one first scan sub-line located in the fourth metal layer, and in the direction perpendicular to the plane of the substrate, the at least one first scan sub-line intersects with and is insulated from the second line segment.

14. The display panel according to claim 12, wherein in the direction perpendicular to the plane of the substrate, the scan line intersects with and is insulated from the reset signal line;
the display panel further comprises a third metal layer and a fourth metal layer, the third metal layer is located between the second metal layer and the first metal layer, and the fourth metal layer is located at a side of the second metal layer close to the substrate; and
the scan line comprises at least one second scan sub-line located in the third metal layer; the pixel circuit comprises a first transistor, a gate of the first transistor is located in the fourth metal layer, and the gate of the first transistor is connected to the second scan sub-line through a through-hole.

15. The display panel according to claim 8, wherein the shift register units comprise a first shift register unit and a second shift register unit, the scan lines comprise a first scan line and a second scan line, two sites on the first scan line are connected to two first shift register units, and two sites on the second scan line are connected to two second shift register units;
the driving signal line comprises a first driving signal line and a second driving signal line, the first shift register unit is connected to the first driving signal line, and the second shift register unit is connected to the second driving signal line; and
in one of the first regions, an arrangement manner of the first shift register unit and the first driving signal line is the same as an arrangement manner of the second shift register unit and the second driving signal line.

16. The display panel according to claim 15, wherein a plurality of circuit groups are arranged in a circuit column in the second direction; and
in one of the first regions, a circuit column where the first shift register unit is disposed is adjacent to a circuit column where the second shift register unit is disposed.

17. The display panel according to claim 8, wherein the shift register units comprise a first shift register unit and a second shift register unit, the scan lines comprise a first scan line and a second scan line, two sites on the first scan line are connected to two first shift register units, and two sites on the second scan line are connected to two second shift register units; and
at a position of a same pixel circuit row in one of the first regions, the first shift register unit and the second shift register unit are located at a same side of the circuit group in the second direction.

18. The display panel according to claim 2, wherein the shift register units comprise a first shift register unit and a second shift register unit, the scan lines comprise a first scan line and a second scan line, two sites on the first scan line are connected to two first shift register units, and two sites on the second scan line are connected to two second shift register units;
the display panel comprises a first virtual line extending along a second direction, the second direction intersects with the first direction; in the first direction, a distance between the first virtual line and an edge of the pixel circuit row is L/4; and each of two first regions comprises a respective one first virtual line; and
in the first region, the first shift register unit and the second shift register unit are located at two sides of the first virtual line.

19. The display panel according to claim 2, wherein the pixel circuit comprises a data writing module, a gate reset module and a light-emitting control module;
the shift register units comprise a first shift register unit and a second shift register unit, the scan lines comprise a first scan line and a second scan line, two sites on the first scan line are connected to two first shift register units, and two sites on the second scan line are connected to two second shift register units;
the second shift register unit comprises a first gate shift register unit and a second gate shift register unit, the second scan line connected to the first gate shift register unit is connected to the gate reset module, and the second scan line connected to the second gate shift register unit is connected to the data writing module; and
the first scan line is connected to the light-emitting control module.

20. A display device, comprising a display panel, comprising shift register units, scan lines and pixel circuits, wherein
the pixel circuits are arranged in a pixel circuit row in a first direction, one of the scan lines extends along the first direction and is connected to the pixel circuits in the pixel circuit row, and a length of the pixel circuit row in the first direction is L;
a display region of the display panel comprises at least two first regions, wherein a width of one first region of the at least two first regions in the first direction is L/10, the pixel circuit row comprises a first edge and a second edge opposite to the first edge in the first direction, a minimum distance between the first edge and one of the at least two first regions is L/5, and a minimum distance between the second edge and another one first region of the at least two first regions is L/5; and
one scan line of the scan lines comprises two sites, one first region of the at least two first regions is provided with a respective one of the two sites, and one site of the two sites is correspondingly connected to an output terminal of a respective one shift register of the shift register units.
